(19) United States
(12) Patent Application Publication
(10) Pub. No.: US 2018/0273193 A1
(43) Pub. Date: Sep. 27, 2018

(54) ELECTRICALLY OPERATED PROPELLANT THRUST ASSIST FOR SUPPLEMENTING AIRPLANE TAKEOFF, LANDING OR IN-FLIGHT MANEUVERABILITY

(71) Applicant: Raytheon Company, Waltham, MA (US)

(72) Inventors: Matt H. Summers, Marana, AZ (US); Frederick B. Koehler, Tucson, AZ (US); James K. Villarreal, Tucson, AZ (US); Mark T. Langhenry, Tucson, AZ (US)

(21) Appl. No.: 15/469,026

(22) Filed: Mar. 24, 2017

(51) Int. Cl. B64D 27/02; B64D 31/02; F02K 9/97; F02K 9/08; C06B 33/06

(52) U.S. Cl. CPC B64D 27/023; B64D 31/02; F02K 9/97; F05D 2240/35; C06B 33/06; F05D 2220/80; F02K 9/08

(57) ABSTRACT

Electrically operated propellant thrust assist supplements an airplane's takeoff, landing or inflight maneuvers. Unlike conventional SRM propellants, the burn rate of the electrically operated propellant can be varied via an electrical input and even extinguished by interrupting the electrical to control a secondary thrust profile (e.g., amplitude, transition rates) to fulfill the needs of a given takeoff, inflight or landing maneuver and provide a smooth transition in and out of the maneuver. Multiple pairs of fixed thrusters (opposite sides of the fuselage), a single pair of gimbaled thrusters or a hybrid of fixed and gimbaled thrusters may be configured to provide all such maneuvers. Flight control inputs are passed back and forth through an interface to enable the thrust assist.

### BACKGROUND OF THE INVENTION

### Field of the Invention

This invention relates to thrust assist to supplement airplane takeoff, landing or inflight maneuvers.

### Description of the Related Art

Assisted takeoff is any system for helping aircraft into the air (as opposed to strictly under its own power). The reason it might be needed is due to the aircraft's weight exceeding the normal maximum takeoff weight, insufficient power, insufficient available runway length, or a combination of all three factors

Jet-Assisted Take Off (JATO) and the similar Rocket-Assisted Take Off (RATO) are a type of assisted takeoff for helping aircraft into the air by providing additional thrust in the form of small rockets mounted on the fuselage, which are used only during takeoff. After takeoff the engines are either jettisoned or else just add to the parasitic weight and drag of the aircraft. These rockets are solid rocket motor assemblies that are mechanically and electrically interfaced with the large aircraft. Typically, four rockets are attached to each side of the fuselage at approximately a 45-degree angle down and aft. The vertical thrust provides a direct and immediately lift component. The horizontal thrust adds to the conventional lift by increasing the speed of the aircraft. All of the rockets are fired simultaneously in response to a single fire command and burn to completion. See U.S. Pat. Nos. 2,563,265; 2,544,830; 2,644,396 and 2,998,703 for various JATO systems that use solid rocket motor (SRM) propellants.

Application of small-scale SRMs to provide thrust assist for unmanned aerial vehicles (UAVs) has been ineffective. The thrust output has proven to be too high and too abrupt for the lighter weight UAVs.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides electrically operated propellant thrust assist for airplanes to supplement takeoff, landing or inflight maneuvers. The burn rate can be varied and even extinguished to control a secondary thrust profile (e.g., amplitude, duration and transition rates) to fulfill the needs of a given takeoff, inflight or landing maneuver and provide a smooth transition in and out of the maneuver. Multiple pairs of fixed thrusters (opposite sides of the fuselage), a single pair of gimbaled thrusters (opposite sides of the fuselage) or a hybrid of fixed and gimbaled thrusters may be configured to provide all such maneuvers. Flight control inputs are passed back and forth through an interface between the airplane and thruster to enable the thrust assist.

In an embodiment, a thrust assist system comprises a variable output thruster, a power supply, a thruster-to-airplane interface and a controller. The variable output thruster includes a combustion chamber, at least one nozzle in communication with the combustion chamber and an electrically operated propellant. The propellant exhibits a self-sustaining threshold pressure (e.g., 1,000, 2,000 or higher psi) at which the propellant once ignited by an electrical input cannot be extinguished by interruption of the electrical input and below which the propellant can be extinguished by interruption of the electrical input. The controller is coupled to the power supply and responsive to flight control inputs received via the interface to control the electrical input to ignite the propellant and throttle the burn rate to generate pressurized gas within the chamber according to a pressure/thrust profile in which pressures in the chamber never exceed the self-sustaining threshold pressure and to interrupt the electrical input to extinguish the propellant at chamber pressures up to the self-sustaining threshold. Pressurized gas in the combustion chamber is directed through the at least one nozzle to produce a secondary thrust including a secondary thrust component along a longitudinal axis of the airplane to augment a primary thrust produced by the airplane engine and vary the lift to allow the airplane to perform flight maneuvers beyond the primary thrust capabilities of the engine.

In an embodiment, the electrically operated propellant comprises a perchlorate based oxidizer of approximately 50 to 90 percent of the mass of the electrically operated propellant, a binder of approximately 10 to 30 percent of the mass of the electrically operated propellant and a metal based fuel of approximately 5 to 30 percent of the mass of the electrically operated propellant. The self-sustaining threshold pressure is at least 1,000 psi, 2,000 psi or higher.

In an embodiment the interface receives a motor on signal from the airplane to apply power from the power supply to the thruster and a measurement of the airspeed of the airplane. The interface may receive a secondary thrust profile specifying an amplitude and duration of burn from the airplane. The controller controls the electrical input to implement the specified secondary thrust profile. The interface may receive a measurement of external air pressure from the airplane, which the controller incorporates to maintain the secondary thrust. In an embodiment, the thruster further comprises a pressure sensor for measuring a pressure inside the combustion chamber. The controller uses the pressure measurement to estimate an amount of electrically operated propellant remaining, and as a secondary estimate of thrust, as necessary. The interface passes the chamber pressure and amount of electrically operated propellant to the airplane.

These and other features and advantages of the invention will be apparent to those skilled in the art from the following detailed description of preferred embodiments, taken together with the accompanying drawings, in which:

### BRIEF DESCRIPTION OF THE DRAWINGS

FIGS. 1a, 1b and 1c are a section drawing, block diagram and pressure plot of a thrust assist system based on electrically operated propellant for supplying secondary thrust for an airplane;

FIGS. 2a, 2b and 2c are diagrams illustrating primary and secondary lift components during takeoff, inflight and landing maneuvers;

FIG. 3 is a diagram of an airplane with a thrust assist system including fixed pairs of electrically operated propellant thrusters for takeoff, landing and roll, pitch and yaw maneuvers;

FIGS. 4a-4c are diagrams of an airplane with a thrust assist system including a single pair of gimbaled electrically operated propellant thrusters for takeoff, landing and roll and yaw maneuvers; and

FIG. 5 is a block flow diagram for controlling electrically operated propellant thrusters.

### DETAILED DESCRIPTION OF THE INVENTION

The present invention provides electrically operated propellant thrust assist for airplanes to supplement takeoff, landing or inflight maneuvers. Unlike conventional SRM (Solid Rocket Motor) propellants, the burn rate of the electrically operated propellant can be varied via an electrical input and even extinguished by interrupting the electrical input to control a secondary thrust profile (e.g., amplitude, transition rates) to fulfill the needs of a given takeoff, inflight or landing maneuver and provide a smooth transition in and out of the maneuver. Multiple pairs of fixed thrusters (opposite sides of the fuselage), a single pair of gimbaled thrusters or a hybrid of fixed and gimbaled thrusters may be configured to provide all such maneuvers. Flight control inputs are passed back and forth through an interface to enable the thrust assist.

All propellants are a combination of oxidizer, fuel, binder and additives. The oxidizer provides oxygen required to burn the fuel. The binder provides a structural material to bind the fuel and oxidizer. The binder itself is a fuel. Additional fuel may or may not be required. Additives may be used for a variety of purposes including to assist curing of the propellant, to control the burn rate, etc.

SRM propellants are ignited thermally and burn vigorously to completion of the propellant. Once ignited, SRM propellants cannot be “turned off” except by a violent and uncontrolled depressurization. The most common oxidizer for SRM propellants is a solid ammonium perchlorate (AP), which has ionic bonds but does not provide the ionic properties for free-flowing ions required for electrical control. Electrical propellants use “ionic-based” oxidizers such as HAN (U.S. Pat. No. 8,857,338) or an ionic perchlorate-based oxidizer (U.S. Pat. No. 8,950,329) that have properties (combination of pyroelectricity, ohmic heating, and thermochemistry) that form a propellant with free-flowing ions that can be controlled by the application of electrical power. Increasing the electrical power increases the burn rate of the propellant. Electrical propellants exhibit a self-sustaining threshold pressure at which the propellant once ignited cannot be extinguished by interruption of the electrical input and below which the propellant can be extinguished by interruption of the electrical input. The HAN based propellants exhibit a threshold of about 150 psi. The perchlorate-based propellants exhibit a threshold greater than 200, 500, 1,500 and 2,000 psi. Electrical propellants exhibit a lower specific impulse (Isp) than SRM propellants, thus requiring either a larger thruster or a longer burn time to produce an equivalent total impulse power.

In an embodiment, the electrically operated propellant comprises a perchlorate based oxidizer of approximately 50 to 90 percent of the mass of the electrically operated propellant, a binder of approximately 10 to 30 percent of the mass of the electrically operated propellant, and a metal based fuel of approximately 5 to 30 percent of the mass of the electrically operated propellant. The propellant may exhibit a threshold of 2,000 psi or higher.

For purposes of this invention an “airplane” is defined as a powered flying vehicle with fixed wings and a weight greater than the air it displaces. The “fixed wings” may be permanently fixed or deployed from a stored position and fixed. The airplane may be manned, unmanned or include a “man-in-the-loop”. Primary thrust is provided along a longitudinal axis by an air-breathing (e.g., propeller, turbofan, jet, . . . ) or electric engine. Air-breathing engines include fuel tanks from which fuel must be pumped into the engine. The airplane includes a fixed lift structure having a fuselage, fixed wing structure (permanent or once deployed) and stabilizers, configured to produce lift in response to the primary thrust producing airflow over the fixed wing structure, fuselage, and stabilizers. One or more control surfaces on the fixed wing structure or stabilizers are controlled to modify the lift to perform maneuvers during takeoff, inflight and landing.

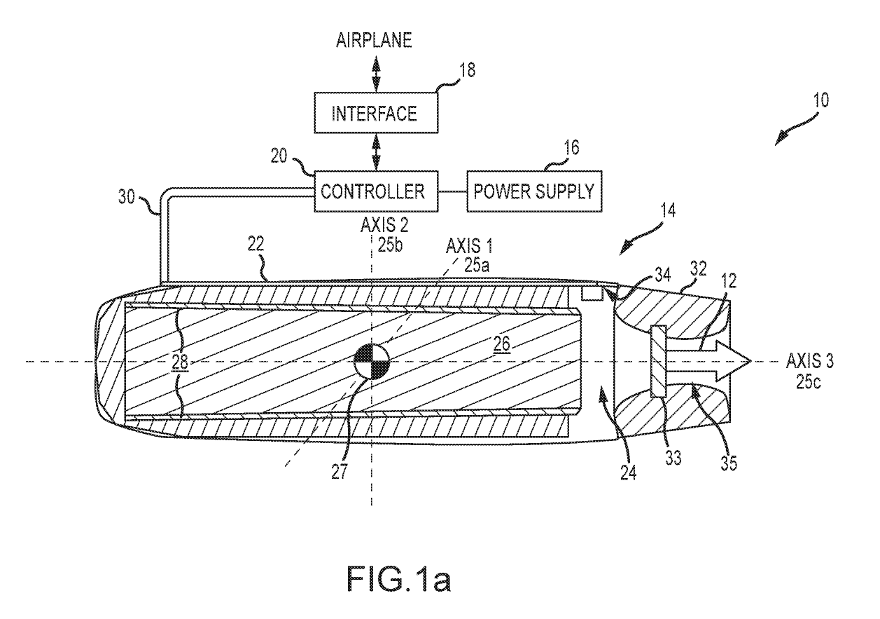

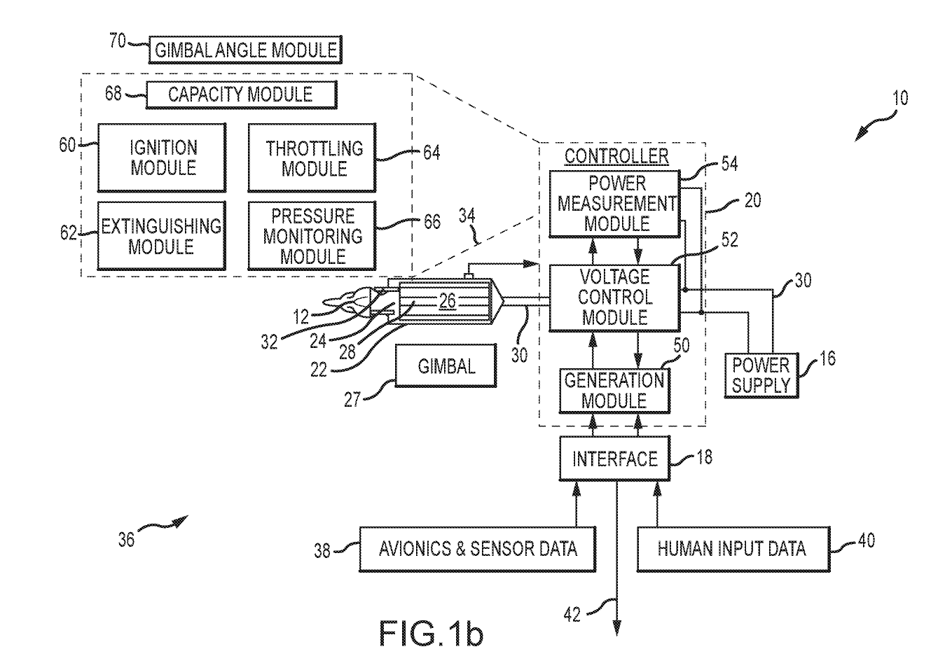

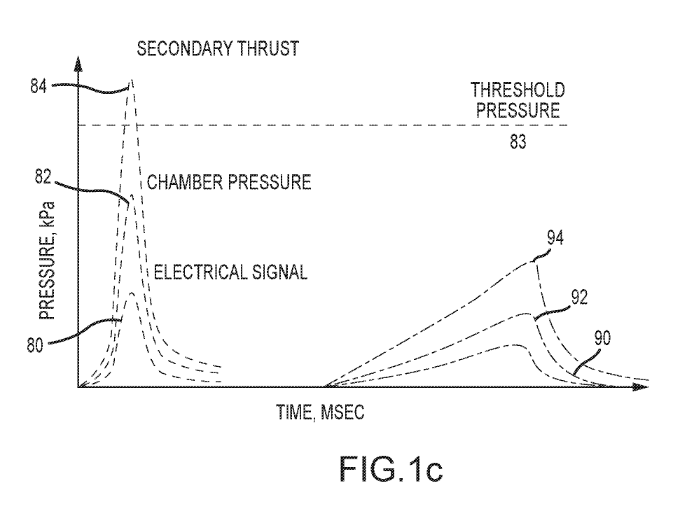

Referring now to the figures, an embodiment of an electrically operated propellant thrust assist system 10 for use with an airplane is illustrated in FIGS. 1a-1c. Thrust assist system 10 is configured to generate a secondary thrust 12 including a secondary thrust component along the longitudinal axis to augment the primary thrust and vary the lift to allow the airplane to perform flight maneuvers beyond the primary thrust capabilities of the engine. The thrust assist system 10 is oriented, fixed or gimbaled, such that the secondary thrust component along the longitudinal axis is non-zero to modify the lift (via the lift equation) by moving the airplane faster or slower. The thrust assist system 10 may also produce a secondary thrust component orthogonal to the longitudinal axis to provide direct lift to perform the flight maneuver. The direct lift component is immediate but does not leverage the lift equation. For stability of the airplane in and out of maneuvers and to produce enough lift to perform the maneuver, it is critical that the secondary thrust component along the axis is non-zero.

Thrust assist system 10 comprises a variable output thruster 14, a power supply 16 (e.g., a battery pack), a thruster-to-airplane interface 18 and a controller 20.

Thruster 102 includes a thruster body 22 with a combustion chamber 24 having an electrically operated propellant 26 positioned therein and encased by liner materials and insulators. The thruster body 22 may be mounted to either side of the airplane with a fixed orientation or mounted on a 1 or 2-axis gimbal 27 to provide a controllable orientation during a phase of flight (e.g. takeoff, inflight or landing) or to reorient the thruster between phases about axis 1, 2 and 25a-25c. Two or more electrodes 28 extend into the electrically operated propellant 26 within the combustion chamber 24. Wires 30 connect electrodes 28 to power supply 16 via controller 20. A nozzle 32 is coupled to combustion chamber 24. Electrically operated propellant 26 includes a formulation that allows for the ignition and extinguishing of the propellant in a variety of conditions according to the application (and interruption of the application) of electricity through the electrodes 28. For instance, the electrically operated propellant 26 is configured to ignite with the application of voltage across the electrodes 28. Conversely, the electrically operated propellant 26 is extinguished with the interruption of the voltage at a range of chamber pressures (e.g., from 500 psi to 2000 psi or higher) less than the self-sustaining threshold pressure. Ignition and combustion of the electrically operated propellant 26 produces elevated chamber pressures. A pressure sensor 34 is in one example coupled with the combustion chamber 24 and is able to measure the pressure within the combustion chamber. At ignition, a weather seal or burst disk 33 blows out and gas is exhausted through a throat 35 of nozzle 32 to generate high pressure/high velocity gas that provides the secondary thrust 12.

Many different configurations of electrodes 28 are possible including but not limited to embedded wires, parallel plates, concentric plates, tapered plates, or moveable plate electrodes. “Electrode Ignition and Control of Electrically Operated Propellants” application Ser. No. 15/197,421, filed Jun. 29, 2016 discloses alternative electrode configurations. “Actuator structure and Method of Ignition of Electrically Operated Propellant” application Ser. No. 15/247,194, filed Aug. 25, 2016 discloses a moveable electrode structure. Alternately, the electrical input for ignition of the electrically operated propellant may be provided directly via a microwave source without using electrodes. “Microwave Ignition of Electrically Operated Propellants” application Ser. No. 15/240,932, filed August 18, discloses such a technique.

Thruster-to-airplane interface 18 receives flight control inputs 36 from the airplane in the form of avionics and sensor data 38 and human input data 40 and forwards thruster data 42 to the airplane. Flight control inputs 36 include a “motor on” signal from the airplane to apply power from the power supply to the thruster and a measurement of the airspeed of the airplane. Unlike a SRM propellant, electrically operated propellant 26 requires a continuous supply of power to support combustion. If power is lost, or the “switch” is open, the thruster fails safe and shuts off. Flight control inputs 36 may also include a specified secondary thrust profile including thrust amplitude, duration and transitions in and out of a maneuver, human inputs such as manual controls, button pushes, verbal inputs, body movement inputs and avionics and sensor data such as external air pressure, temperature, airflow etc. Thruster data 42 may include a pressure sensor measurement inside the combustion chamber and an amount of electrically operated propellant remaining.

Controller 20 is shown as including in one example a generation module 50. The generation module 50 is coupled with a voltage control module 52 and a power measurement module 54. The generation module 50 is configured to control the amount of secondary thrust provided as part of a rocket motor. For instance, as ignition, extinguishing and throttling of thrust output from the thruster 10 is desired, the flight module is configured to provide this control by way of management of the electrical output to the thruster through control of the voltage control module 52.

The voltage control module 52 is coupled along the electrical circuit between the power source 16 and the thruster 10 to function, in part, as a “switch” in response to the “motor on” signal. The voltage control module 52 is in one example coupled with the power measurement module 54. The power measurement module is configured to measure the output of the power source and thereby facilitate control and administration of the appropriate amount of electricity such as voltage, current or the like to the thruster through the voltage control module.

In an embodiment, the generation module 50 includes one or more of an ignition module 60 to control the application of the electrical input to the electrically operated propellant via the electrodes, an extinguishing module 62 to interrupt the application of the electrical input to extinguish combustion, a throttling module 64 to vary the electrical input to increase or decrease the burn rate, a pressure monitoring module 66 to measure the chamber pressure via pressure sensor 34 to provide feedback to the other modulates to control ignition, extinguishment and throttling, a capacity module 68 to estimate an amount of electrically operated propellant remaining, and a gimbal angle module 70 to compute an angle or sequence of angles to drive gimbal 27 (assuming the thruster is gimbaled and not fixed). Chamber pressure is a critical parameter to ensure that the proper secondary thrust is generated, to ensure that combustion of the propellant can be extinguished (and reignited) and to estimate the amount of remaining propellant. The pressure data is used to determine the thrust, from which and assuming a typical efficiency, an amount of expelled mass is calculated. Each of these modules controls various corresponding functions of the thruster 10.

As shown in FIG. 1c, a first electrical input 80 is applied to ignite and combust the electrically operated propellant. The burn rate of the propellant is proportional to the amplitude of the electrical input producing a chamber pressure 82 (less than the propellant's threshold pressure 83) exhaustion of which through the nozzle produces a secondary thrust 84. The amplitude, duration and smooth transition of the secondary thrust 84 into and out of a flight maneuver is directly controlled by electrical input 80. In this embodiment, once a first flight maneuver is completed, interrupting first electrical input 80 exhausts combustion of the propellant. At a subsequent time, either within the same phase of flight or at a different phase of flight, a second electrical input 90 with different amplitude, duration and transitions is applied to ignite and combust the electrically operated propellant to produce a chamber pressure 92 and secondary thrust 94.

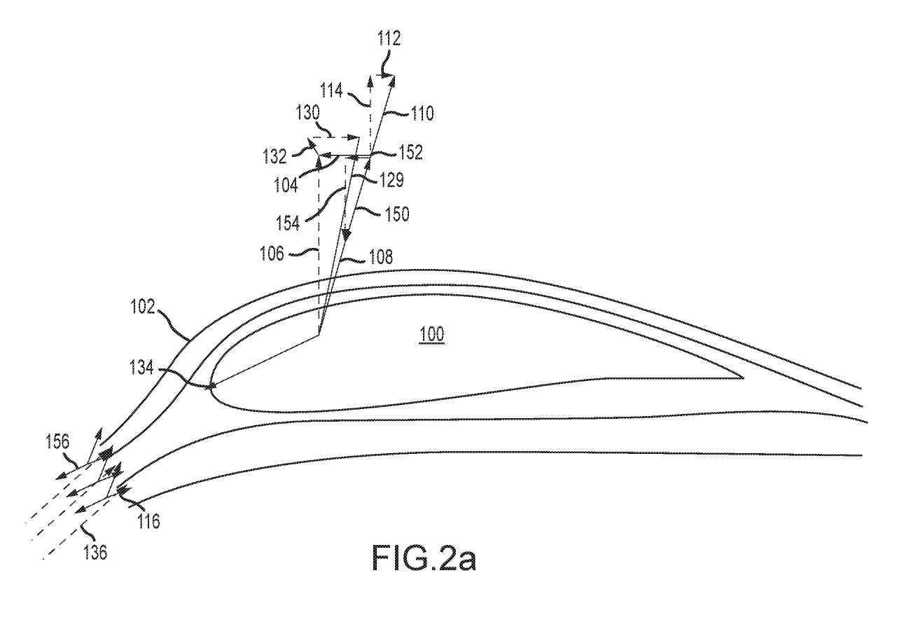

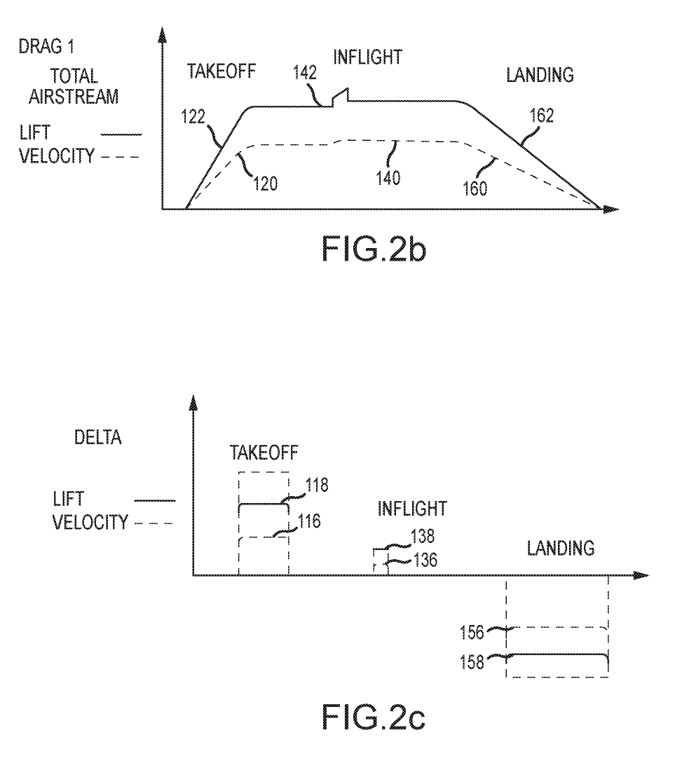

Referring now to FIGS. 2a-2c, the interaction of a primary thrust generated by the airplane's engine and a secondary thrust generated by an electrically operated propellant thrust assist system to produce and modify lift to perform flight maneuvers beyond the primary thrust capabilities of the engine are illustrated for the takeoff, inflight and landing phases of flight.

As primary thrust is generated, a force is imparted on the airplane, and depending on the given mass of the airplane, the airplane will accelerate at different rates for a given thrust level. As the airplane accelerates, its velocity at any given point in time is increasing (acceleration is assumed to be positive, while deceleration is assumed to be negative). In this state, one can think about the situation two ways: 1) a fixed volume of air with an airplane moving through it OR 2) a fixed body of an aircraft e.g., a wing 100 with a moving airstream 102 moving towards it. For the purposes of simplifying the discussion, it is preferred to think of the situation in the second case, where the airplane is a fixed body, and there is a steady stream of air moving towards the airplane at a given velocity. For any oncoming airstream velocity, U_{∞}, forces are generated aerodynamically across the airfoils on the airplane. These forces at the most basic level consist of a single force in the x-direction, Fx 104, and a single force in the y-direction, Fy 106, at each per unit span of the wing. The Fx force is drag, and the Fy force is lift. Summed together Fx and Fy make up a vector of total force generated from a given U_{∞}, called \vec{F} 108.

As U_{∞} is increased, Fx 104 and Fy 106 increase as well. Likewise, if U_{∞} is decreased, Fx and Fy decrease. When the value of Fy becomes greater than the total weight of the airplane, the airplane is accelerating in an upward direction. Likewise, when the value of Fy becomes less than the total weight of the airplane, the airplane is accelerating in a downward direction. To maintain a level horizontal altitude, the aerodynamic force generated by the wings must be equal to that of the weight of the aircraft.

The following equations are general equations that can be used to describe the lift and drag as a function of given airspeed, U_{∞}, for a per unit span of the wings, hence why no dimensional variable for the length of the wings or quantity of wings is included.

Lift=L=F_{y}=1/2ρU_{∞}²C_{L}c

Drag=D=Fₓ=1/2ρU_{∞}²C_{D}c

where L is lift, D is drag, ρ is air density, U_{∞} is mean air velocity, C_{D} is coefficient of drag, C_{L} is coefficient of lift and c is chord length of the wing.

Secondary thrust modifies the velocity of the airplane, which in turn modifies the lift to perform a specified flight maneuver. This additional velocity equates to a change in lift and drag by the following equations.

U_{∞,new}=U_{∞,0}+U_{aug}

Lift=L=F_{y}=1/2ρU_{∞,new}²C_{L}c

Drag=D=Fₓ=1/2ρU_{∞,new}²C_{D}c

where U_{aug} value corresponds to the augmented oncoming velocity of the airflow and U_{∞,new}—new mean air velocity (which includes all thrust generating systems).

Unlike the conventional SRM propellants used for JATO/RATO, which once ignited burned at a constant rate (constant thrust) until the propellant was fully consumed (fixed duration) and exhibit abrupt on and off transitions, the electrically operated propellant thruster provides flexibility to tailor the thrust profile (amplitude, duration, on/off transitions) to the demands of a flight maneuver, to be turned on and off to provide multiple shots within a given phase of flight or in different phases of flight, and to reorient the thruster for takeoff, inflight maneuvers and landing.

For any additional airstream velocity, U_{aug}, additional forces are generated aerodynamically across the airfoils on the airplane. These forces at the most basic level consist of a single force in the x-direction, Fx, and a single force in the y-direction, Fy, at each per unit span of the wing. The Fx force is drag, and the Fy force is lift. These forces augment (increase or decrease) the forces produced by the primary thrust to modify the total lift profile.

During takeoff, a secondary thrust component is produced along the axis of the airplane that increases the velocity of airstream 102 moving over wing 100. The additional velocity produces a force 110 made up of a drag force Fx 112 and an additional lift force Fy 114. These forces produce a delta velocity 116 equal to the horizontal acceleration and a delta lift 118 equal to the vertical acceleration, which in turn produce a total velocity 120 and a total lift 122 that exceed the primary thrust capability of the airplane engine. The electrically operated propellant thruster may be oriented (e.g., two thrusters on either side of the fuselage at an approximately 45 degree angle to the longitudinal axis) and controlled to produce a secondary thrust profile (e.g. fixed amplitude, fixed burn time, abrupt on/off transitions) to mimic the conventional SRM rockets for conventional JATO/RATO. Alternately, the thruster may be controlled to produce a secondary thrust profile with variable amplitude during takeoff, a controllable burn time dictated by takeoff requirements and smooth on/off transitions into and out of takeoff. This secondary thrust profile may vary depending on properties of the aircraft (e.g., size, weight, takeoff speed) and takeoff properties (e.g., runway length, wind conditions etc.). If gimbaled, the thruster can be re-oriented during takeoff to optimize the secondary thrust contribution.

Inflight, a secondary thrust component is produced along the axis of the airplane that increases or decreases the velocity of airstream 102 moving over wing 100 to produce a force F 129 including drag force Fx 130 and lift force Fy 132 while also producing a direct force component Fz 134 orthogonal to the longitudinal axis of the airplane to produce a yaw, pitch or roll moment to produce a desired inflight maneuver. As previous mentioned it is critical that the thruster is oriented to produce both a non-zero secondary thrust component along the axis to augment lift and a non-zero thrust component orthogonal to an axis to perform Y/P/R maneuver. When dealing with large airplanes moving at high speeds, it is critical that the transitions in and out of any Y/P/R maneuver are smooth and not abrupt to maintain the stability and integrity of the airplane. These forces produce a delta velocity 136 equal to the horizontal acceleration and a delta lift 138 equal to the vertical acceleration, which in turn produce a total velocity 140 and a total lift 142 that exceed the primary thrust capability of the airplane engine. As will be detailed subsequently, inflight maneuvers may be enabled using a single pair of gimbaled thrusters mounted on either side of the fuselage or under wing. A 1-axis gimbal would support one of Y/P/R and a 2-axis gimbal would support two or three of Y/P/R depending on positioning of the gimbal relative to Cg. Alternately, pairs of thrusters can be mounted on the fuselage or under wing with a fixed orientation to enable a specific Yaw, Pitch or Roll maneuver. The thrusters are not oriented orthogonal to the longitudinal axis of the aircraft to ensure that a non-zero secondary thrust component is produced along the axis as well as the direct orthogonal component. The thrusters are bounded away from an orthogonal orientation to the longitudinal axis (to rotate about axis 1, 2 or 3) by a finite amount x to ensure the existence of the non-zero secondary thrust component. The magnitude of x could be as little as a few degrees and as much as tens of degrees depending on the mechanical limitation of the aircraft, airspeeds, amount of thrust produced and the severity of the inflight maneuvers.

During landing, a secondary thrust component is produced along the axis of the airplane that decreases the velocity of airstream 102 moving over wing 100. The additional velocity produces a force 150 made up of a drag force Fx 152 and an additional lift force Fy 154. These forces produce a delta velocity 156 resultant from the horizontal acceleration and a delta lift 158 resultant from the vertical acceleration, which in turn produce a total velocity 160 and a total lift 162 that exceed the primary thrust capability of the airplane engine. The electrically operated propellant thruster may be oriented (e.g., two thrusters on either side of the fuselage at an approximately 180 degree angle to the longitudinal axis) and controlled to produce a secondary thrust profile (e.g. fixed amplitude, fixed burn time, abrupt on/off transitions) to reduce airspeed. Alternately, the thruster may be controlled to produce a secondary thrust profile with variable amplitude during landing, a controllable burn time dictated by takeoff requirements and smooth on/off transitions into and out of landing. This secondary thrust profile may vary depending on properties of the aircraft (e.g., size, weight, takeoff speed) and takeoff properties (e.g., runway length, wind conditions etc.). If gimbaled, the thruster can be re-oriented during landing to optimize the secondary thrust contribution.

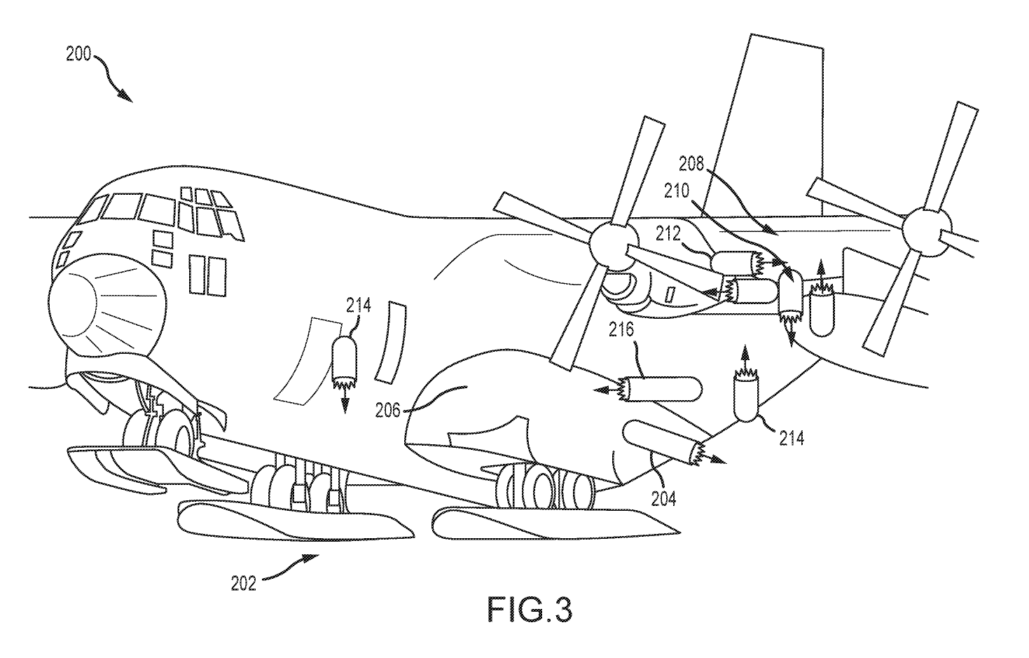

Referring now to FIG. 3, in an embodiment, an airplane 200 is outfitted with a thrust assist system 202 comprising only fixed orientation electronically operated propellant thrusters to perform takeoff, inflight Y/P/R and landing maneuvers. Fixed systems may have actual or perceived advantages of reliability, weight and cost versus a gimbaled system. The different thrusters may be sized as appropriate for the different maneuvers. Other than the pitch thrusters, the thrusters are suitably positioned at or near the center of gravity Cg of the airplane to minimize the creation of unwanted moments that complicate flight control. Only the thrusters on the left side of the airplane are shown.

A pair of thrusters 204 is mounted on opposing sides of fuselage 206, and typically symmetrically, at approximately a 45 degree angle to the longitudinal axis of the airplane. The orientation is similar to conventional JATO/RATO SRM rockets but the thrusters maintain the benefit of a variable output thrust capability for takeoff.

Six pair of thrusters are mounted on opposing sides of fuselage 206 under wing 208, two pair each and preferably symmetrically, to perform yaw, pitch and roll maneuvers in flight. Two pair of thrusters 210 are oriented to provide force components along and orthogonal to axis 1 in FIG. 1a. In a first pair, a left thruster is pointed down and a right thruster is pointed up to roll clockwise about the longitudinal axis. In a second pair, a right thruster is pointed up and a left thruster is pointed down to roll counter clockwise about the longitudinal axis. Similarly, pairs of thrusters 212 and 214 are oriented to provide force components along and orthogonal to axis 2 and axis 3 in FIG. 1b to perform yaw and pitch maneuvers. Thrusters 214 are placed fore and aft of the Cg in order to perform the pitch maneuver. The closer the orientation of the thrusters is to 90 degrees to the axis the greater the thrust component to perform the yaw, pitch or roll maneuver. Conversely, the greater the thrust component along the axis to augment lift, the smoother the transition in and out of the yaw, pitch or roll maneuver. The exact balance between the components is determined by mechanical properties of the airplane, airspeed, and the required flight maneuvers. In some cases, the orientation of the thrusters may be near (but not equal to 90 degrees). In other cases, the orientation of the thrusters could be near, for example, 70 degrees. The variable output thrust and multi-shot capability of the electrically operated propellant thrusters provides considerable capability to maneuver the airplane in flight beyond the capabilities of the engine itself.

A pair of thrusters 216 is mounted on opposing sides of fuselage, and typically symmetrically, at approximately a 180-degree angle to the longitudinal axis of the airplane to reduce airspeed during landing. The electrically operated propellant thrusters allow the airplane to rapidly and smoothly reduce airspeed during landing.

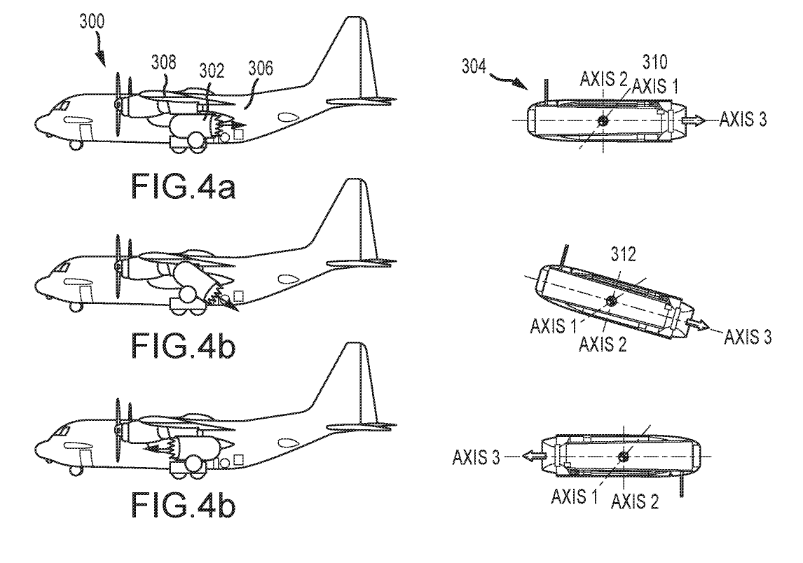

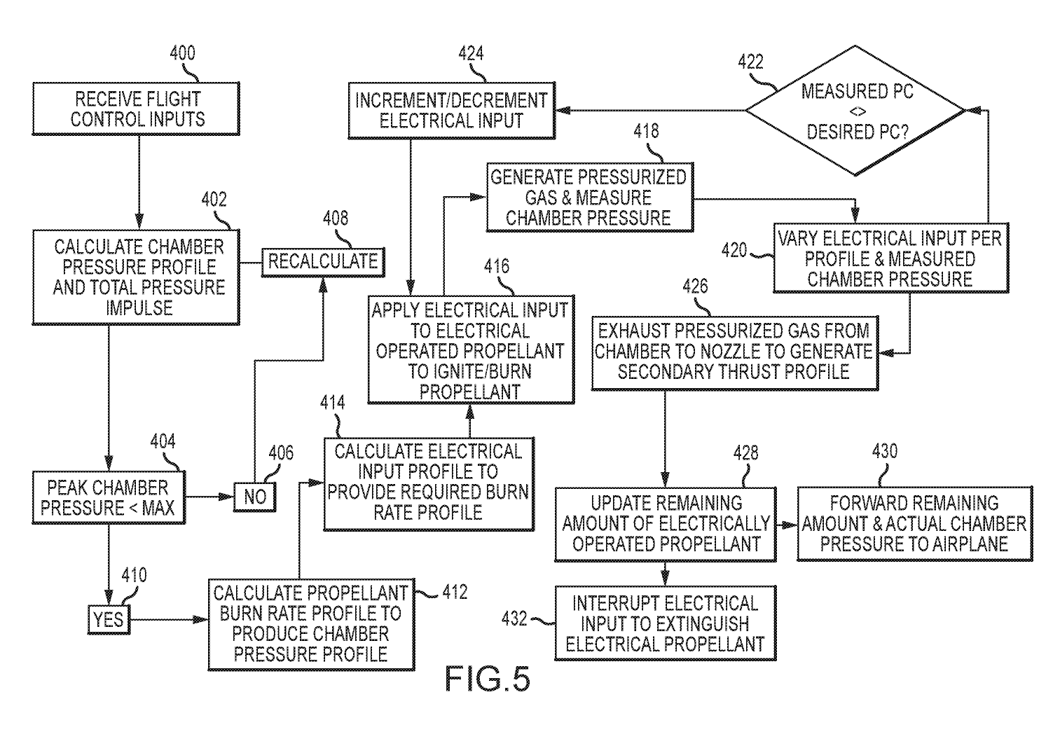

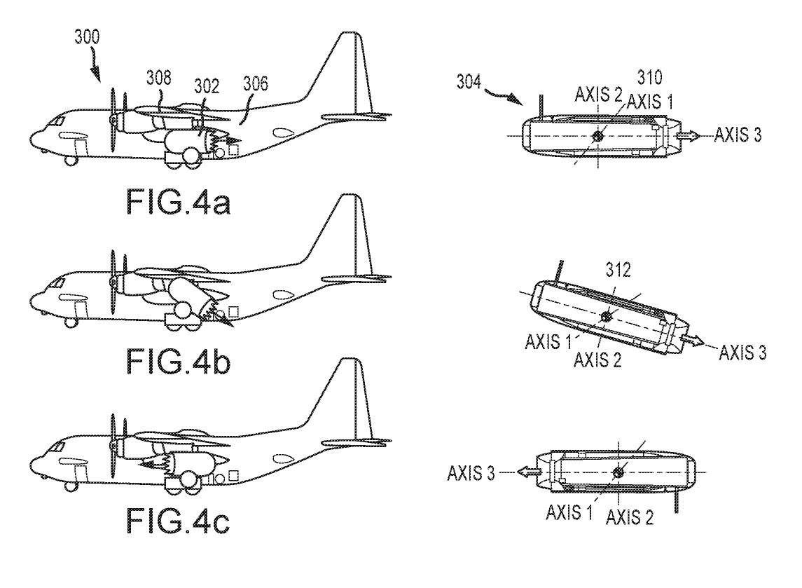

Referring now to FIG. 4, in an embodiment, an airplane 300 is outfitted with a thrust assist system 302 comprising only a single pair of gimbaled electronically operated propellant thrusters 304 to perform takeoff, inflight roll and yaw and landing maneuvers. Gimbaled thrusters reduce the total number of thrusters required to service all of the flight maneuvers and provide the ability to re-orient the thruster to optimize the secondary thrust component for a given takeoff, inflight or landing maneuver. A 2-axis gimbal is used to provide roll and yaw inflight maneuverability requirements. The thrusters 304 are suitably mounted on opposing sides of the fuselage 306 or under wing 308, and preferably symmetrically about the longitudinal axis of the airplane at approximately the Cg of the airplane.

For takeoff, thrusters 304 are rotated about axis 1 310 to provide positive thrust to increase the velocity of the airstream moving over wing 308. The thrusters may be rotated 0 degrees to maximize the increase in velocity to increase lift via the lift equation or may be rotated by a non-zero value e.g., 45 degrees to both increase the velocity to produce lift and to produce a direct force component. The direct force component produces an immediate but smaller lifting effect.

Inflight, thrusters 304 are rotated about axis 1 310 in opposite directions and symmetrically to an angle a where 0<α<180 but not equal to 90 to produce both a positive/negative thrust to increase/decrease the velocity of the airstream and to produce a roll moment as shown in FIG. 4b. Thrusters 304 are rotated about axis 2 312 in opposite directions and symmetrically to an angle β where 0<β<180 but not equal to 90 to produce both a positive/negative thrust to increase/decrease the velocity of the airstream and to produce a yaw moment. To support a pitch maneuver, the gimbaled thrusters 304 would be moved fore or aft of the Cg. While fore and aft of the Cg, the 2-axis gimbal is still sufficient to rotate the thrusters 304 about axis 1 310 in opposite directions and symmetrically to an angle χ where 0<χ<180 to produce both a positive/negative thrust to increase/decrease the velocity of the airstream and to produce the pitch moment.

At landing, thrusters 304 are rotated about axis 1 310 to provide negative thrust to decrease the velocity of the airstream moving over wing 308. The thrusters may be rotated 180 degrees to maximize the increase in velocity to increase lift via the lift equation or may be rotated by a non-zero value e.g., 135 s degrees to both decrease the velocity to reduce lift and to produce a direct downward force component. The direct force component produces an immediate but smaller downward effect.

In alternate embodiments, fixed and gimbaled thrusters may be combined in a “hybrid” thrust assist configuration. For example, pairs of fixed thrusters may be used for takeoff and landing and pairs of gimbaled thrusters to provide inflight maneuvers. Furthermore the fixed or gimbaled thrusters may be physically mounted in many different locations on the aircraft e.g., sides of fuselage at the Cg, fore and aft of Cg, up and down of Cg; inner, mid or outer placement on the wings; under the fuselage under the Cg, above the fuselage over the Cg, under or over the tail, under or over the nose, sides of the nose

Referring now to FIG. 5, an embodiment of a method for controlling the electrical input applied to electrically operated propellant to produce a secondary thrust profile receives flight control inputs from the airplane (step 400). Flight control inputs include human and sensor inputs that define a secondary thrust profile to assist the primary thrust to perform the flight maneuver.

The thrust assist controller calculates a chamber pressure profile and total pressure impulse to provide the secondary thrust profile (step 402). The controller checks the profile's peak chamber pressure against a maximum allowed chamber pressure (step 404). The maximum is determined at least in part by the self-sustaining threshold pressure of the electrically operated propellant. In order to preserve the ability to turn the propellant on and off, this maximum cannot be exceeded. The maximum may also include structural limitations of the thruster and airplane. If the peak pressure is not less than the maximum (step 406), the controller recalculates (step 408) the chamber pressure profile for the same total pressure impulse. For example, the controller increases the duration of propellant burn thereby decreasing peak chamber pressures to deliver the same total pressure impulse. Once the pressure profile satisfies the maximum pressure requirement (step 410), the controller calculates a propellant burn rate profile to produce the chamber pressure profile (step 412) and calculates an electrical input profile to provide the burn rate profile (step 414).

In response to the “motor on” flight control input, the controller modulates the output of the power supply to apply the electrical input to the electrically operated propellant to ignite and burn the propellant (step 416). Combustion of the propellant generates pressurized gas in the combustion chamber (step 418). A pressure sensor is used to measure the actual chamber pressure. The controller varies the electrical input based on the electrical input profile and the actual chamber pressure to produce the chamber pressure profile (step 420).

Closed-loop feedback may be employed by comparing the measured chamber pressure to the desired chamber pressure (step 422) and adjusting the electrical input to increase or decrease the burn rate, hence chamber pressure (step 424). For example, if the measured pressure is low, the electrical input is incremented to increase chamber pressure. If the measured pressure is high, the electrical input is decremented to decrease chamber pressure.

Pressurized gas is exhausted from the chamber through the nozzle to generate the secondary thrust profile (step 426). As the electrical input is applied to maintain combustion of the propellant, the controller computes the amount of mass of propellant consumed to update the remaining amount of propellant available (step 428). The controller forwards this amount and chamber pressure measurements via the interface to the airplane (step 430). The controller interrupts the electrical input to extinguish the electrical propellant at the end of the current flight maneuver (step 432). The remaining propellant can be reignited and burned to perform a subsequent maneuver in the same phase of flight or a subsequent phase.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A thrust-assisted airplane, comprising:
an air-breathing or electric engine configured to generate a primary thrust along a longitudinal axis;
a fixed lift structure including a fuselage, fixed wing structure and stabilizers, configured to produce lift in response to the primary thrust producing airflow over the fixed wing structure, fuselage, and stabilizers;
one or more control surfaces on the fixed wing structure or stabilizers to modify the lift;
a thrust assist system configured to generate a secondary thrust including a secondary thrust component along the longitudinal axis to augment the primary thrust and vary the lift to allow the airplane to perform flight maneuvers beyond the primary thrust capabilities of the engine, said system comprising,
a thruster including a combustion chamber; at least one nozzle in communication with the combustion chamber and an electrically operated propellant, said propellant exhibiting a self-sustaining threshold pressure at which the propellant once ignited by an electrical input cannot be extinguished by interruption of the electrical input and below which the propellant can be extinguished by interruption of the electrical input;
a power supply;
an interface configured to receive flight control inputs from the airplane;
a controller coupled to the power supply and responsive to the flight control inputs to control the electrical input to ignite the propellant and throttle the burn rate to generate pressurized gas within the chamber according to a pressure/thrust profile in which pressures in the chamber never exceed the self-sustaining threshold pressure and to interrupt the electrical input to extinguish the propellant at chamber pressures up to the self-sustaining threshold,
wherein pressurized gas in the combustion chamber is directed through said at least one nozzle to produce the secondary thrust.

2. The thrust-assisted airplane of claim 1, wherein an orientation of the thruster is fixed.

3. The thrust-assisted airplane of claim 1, further comprising multiple pairs of said thrust assist systems, each pair comprising first and second thrusters positioned at fixed orientations on opposite sides of the longitudinal axis on the fuselage or fixed wing structure, a first said pair configured to produce a first secondary thrust component to increase the primary thrust during liftoff, a second said pair configured to produce a second secondary thrust component to augment the primary thrust component inflight to perform a roll, pitch or yaw maneuver during inflight, and a third said pair configured to produce a third secondary thrust component to reduce the primary thrust component during landing.

4. The thrust-assisted airplane of claim 1, further comprising a gimbal on which the thruster is mounted to change an orientation of the thruster.

5. The thrust-assisted airplane of claim 4, further comprising a pair of said thrust assist systems, said pair comprising first and second thrusters positioned on said gimbals on opposite sides of the longitudinal axis on the fuselage or fixed wing structure, said gimbals configured to orient said first and second thrusters to produce a first secondary thrust component to increase the primary thrust during liftoff, a second secondary thrust component to augment the primary thrust component inflight to perform at least one of a roll, pitch or yaw maneuver during inflight, and produce a third secondary thrust component to reduce the primary thrust component during landing.

6. The thrust-assisted airplane of claim 1, further comprising first and second thrust control systems, said first thrust control system's thruster having a fixed orientation, said second thrust control system's thruster mounted on a gimbal to change an orientation of the thruster.

7. The thrust-assisted airplane of claim 1, wherein the controller controls the electrical input such that the secondary thrust component provides a smooth transition in and out of the flight maneuver.

8. The thrust-assisted airplane of claim 1, wherein the controller applies and interrupts the electrical input multiple times to produce multiple discrete secondary thrust components.

9. The thrust-assisted airplane of claim 1, wherein the self-sustaining threshold pressure is at least 2,000 psi.

10. The thrust-assisted airplane of claim 1, wherein the electrically operated propellant includes an ionic perchlorate-based oxidizer.

11. The thrust-assisted airplane of claim 1, wherein the electrically operated propellant comprises:
a perchlorate based oxidizer of approximately 50 to 90 percent of the mass of the electrically operated propellant;
a binder of approximately 10 to 30 percent of the mass of the electrically operated propellant;
a metal based fuel of approximately 5 to 30 percent of the mass of the electrically operated propellant; and
wherein the self-sustaining threshold pressure is at least 1,000 psi.

12. The thrust-assisted airplane of claim 1, wherein said thruster includes at least two electrodes coupled to the power supply to apply the electrical input to the electrically operated propellant.

13. The thrust-assisted airplane of claim 1, wherein the interface receives a motor on signal from the airplane to apply power from the power supply to the thruster and a measurement of the airspeed of the airplane.

14. The thrust-assisted airplane of claim 13, wherein the interface receives a specified secondary thrust profile specifying an amplitude and duration from the airplane, wherein said controller controls the electrical input to implement the specified secondary thrust profile.

15. The thrust-assisted airplane of claim 13, wherein the interface receives a measurement of external air pressure from the airplane, wherein the controller controls the electrical input to maintain the secondary thrust.

16. The thrust-assisted airplane of claim 13, wherein the thruster further comprises a pressure sensor for measuring a pressure inside the combustion chamber, wherein said controller uses the pressure measurement to estimate an amount of electrically operated propellant remaining, wherein said interface passes the chamber pressure and amount of electrically operated propellant to the airplane.

17. A thrust assist system for an airplane comprising an air-breathing or electric engine configured to generate a primary thrust along a longitudinal axis, a fixed lift structure including a fuselage, fixed wing structure and stabilizers, configured to produce lift in response to the primary thrust producing airflow over the fixed wing structure, fuselage, and stabilizers and one or more control surfaces on the fixed wing structure or stabilizers to modify the lift, said thrust assist system comprising,
a thruster including a combustion chamber; at least one nozzle in communication with the combustion chamber and an electrically operated propellant, said propellant exhibiting a self-sustaining threshold pressure at which the propellant once ignited by an electrical input cannot be extinguished by interruption of the electrical input and below which the propellant can be extinguished by interruption of the electrical input;
a power supply;
an interface configured to receive flight control inputs from the airplane;
a controller coupled to the power supply and responsive to the flight control inputs to control the electrical input to ignite the propellant and throttle the burn rate to generate pressurized gas within the chamber according to a pressure/thrust profile in which pressures in the chamber never exceed the self-sustaining threshold pressure and to interrupt the electrical input to extinguish the propellant at chamber pressures up to the self-sustaining threshold,
wherein pressurized gas in the combustion chamber is directed through said at least one nozzle to produce a secondary thrust including a secondary thrust component along the longitudinal axis of the airplane to augment the primary thrust and vary the lift to allow the airplane to perform flight maneuvers beyond the primary thrust capabilities of the engine.

18. The thrust assist system of claim 17, further comprising a gimbal on which the thruster is mounted to change an orientation of the thruster.

19. The thrust-assisted airplane of claim 17, wherein the electrically operated propellant comprises:
a perchlorate based oxidizer of approximately 50 to 90 percent of the mass of the electrically operated propellant;
a binder of approximately 10 to 30 percent of the mass of the electrically operated propellant;
a metal based fuel of approximately 5 to 30 percent of the mass of the electrically operated propellant; and
wherein the self-sustaining threshold pressure is at least 1,000 psi.

20. The thrust assist system of claim 17, wherein the interface is configured to receive a motor on signal from the airplane to apply power from the power supply to the thruster and a measurement of the airspeed of the airplane.
